(19) United States
(12) Patent Application Publication
(10) Pub. No.: US 2019/0176452 A1
(43) Pub. Date: Jun. 13, 2019

(54) METHOD FOR MANUFACTURING CASE HAVING PATTERNS

(71) Applicants: TRIWOOD TECHNOLOGY CO., LTD., New Taipei City (TW); SHEN TAI RUBBER CO., LTD., Taoyuan City (TW)

(72) Inventors: YI-CHEN WU, NEW TAIPEI CITY (TW); CHUN-LAN CHAO, TAOYUAN CITY (TW)

(21) Appl. No.: 15/834,431

(22) Filed: Dec. 7, 2017

(51) Int. Cl. B32B 37/00; B32B 37/18; B32B 38/10; B32B 27/08; B32B 27/40

(52) U.S. Cl. CPC B32B 37/025; B32B 37/182; B32B 38/10; G06F 1/1626; B32B 27/40; B32B 2451/00; B32B 2571/00; B32B 27/08

(57) ABSTRACT

The preset invention provides a method for manufacturing a case having patterns. By using the properties of repeated adherence and rinsability of the adhesive layer on the patch, an oily figure on an oil-proof figure card is adhered to a transparent case. Then the appearance of the case can be altered at will.

### FIELD OF THE INVENTION

The present invention relates generally to a method for manufacturing a case structure, and particularly to a method for manufacturing a case having patterns.

### BACKGROUND OF THE INVENTION

Smartphones are important personal belongings for modern people. As technologies develop, smartphones enable people to browse information on the Internet and to take pictures anytime and hence become indispensable tools for them. To browse information more conveniently, smartphones with a large display have become the mainstream. Unfortunately, large-display smartphones are vulnerable to impact by external force, resulting in breakage of displays.

In addition, since smartphones have become the mainstream currently, their peripheral products, in particular, the protective cases, enjoy substantial demand and market. Because 3C products require lightweight and thin features, the cases of smartphones adopt light materials, leading to insufficient protection for smartphones. Thereby, most people will add a protective case or cover for their smartphones for avoiding damages due to falls or scratches.

Furthermore, depending on the materials, current protective cases can be categorized into hard and soft smartphone cases. Hard smartphone cases are harder and scratch resistant. Unfortunately, they are less shock absorptive, more brittle. Besides, because they are hard, it is difficult to assemble or disassemble. Sometime, scratches on smartphones can occur during the assembling disassembling process. Contrarily, soft smartphone cases are easier to assemble or disassemble and own excellent buffering effect. Though not brittle, they are vulnerable to scratches.

The soft materials of soft smartphone cases generally include thermoplastic polyurethane (TPU), silica gel, or rubber. To expose the appearance of smartphones, most soft smartphone cases are made of transparent soft materials. Unfortunately, yellowing occurs easily when soft smartphone cases contact acid materials such as palm sweats and hence affecting their appearance. Currently, there is a bi-layer smartphone case, in which the inner layer is a transparent soft material while the outer layer is a hard material. Nonetheless, due to its limitations in thickness and design, it is difficult in assembling to or disassembling from a smartphone.

In addition, modern users generally wish their smartphones to demonstrate different looks in various occasions. Alternatively, they also wish their cell phones would match the styles of their clothing or accessories. Thereby, they change protective cases frequently to decorate their smartphones. Consequently, in addition to protecting phones, protective cases should be well designed to enhance their added values and meet users' requirements.

Nonetheless, the protective cases according to the prior art, no matter hard or soft smartphone cases, are always shipped in fixed appearances designed by the manufacturers. The cases are formed integrally and made of plastic materials. The patterns are low-quality and cannot be replaced. Consequently, users need to purchase multiple protective cases for replacement, which waste time and money.

To customize a protective case, it requires extra transactions with customization providers. Besides, the appearance of a customized protective case cannot be replaced at will. It requires further transactions with customization providers. Thereby, users still need to purchase multiple protective cases for replacement, and still wasting time and money.

It is known that the protective cases according to the prior art are fixed in styles and patterns. It is not possible to alter the appearances of the protective cases according users' requirements. The added values of the protective cases cannot be improved.

Accordingly, how to enhance the added values of protective cases by altering appearance is the major problem to be solved.

### SUMMARY

An objective of the present invention is to provide a method for manufacturing a case having patterns. By using the property of repeated adherence, an oily figure on an oil-proof figure card is attached to a patch and adhered to one side of a transparent case for achieving the effect of altering the appearance of the case at will.

In order to achieve the above objective, the present invention discloses a method for manufacturing a case having patterns, which comprises steps of: providing a patch having a base layer and an adhesive layer; disposing one or more figure on one or more figure card, disposing the adhesive layer on the one or more figure, and adhering the one or more figure to the adhesive layer; removing the one or more figure card; and adhering the adhesive layer to one side of a transparent case.

The present invention provides an embodiment of the method for manufacturing a case having patterns, wherein the material of the one or more figure card is an oil-proof material and the material of the one or more figure is an oily material.

The present invention provides an embodiment of the method for manufacturing a case having patterns, wherein the material of the adhesive layer is an oil-proof glue.

The present invention provides an embodiment of the method for manufacturing a case having patterns, wherein the adhesion between the figure card and the figure is smaller than the adhesion between the adhesive layer and the figure.

The present invention provides an embodiment of the method for manufacturing a case having patterns, and after the step of adhering the adhesive layer to one side of a transparent case, further comprises steps of removing the patch from one side of the transparent case; and rinsing the one or more figure on the adhesive layer of the patch.

The present invention provides an embodiment of the method for manufacturing a case having patterns, and after the step of adhering the adhesive layer to one side of a transparent case, further comprises a step of adhering the adhesive layer to a recess of a smartphone case

The present invention provides an embodiment of the method for manufacturing a case having patterns, wherein the one or more figure card includes a nanostructure on a surface.

The present invention provides an embodiment of the method for manufacturing a case having patterns, wherein the oil-proof material includes silicone resin.

The present invention provides an embodiment of the method for manufacturing a case having patterns, wherein the oily material includes one or more color pencil, one or more crayon, or one or more oily pen.

The present invention provides an embodiment of the method for manufacturing a case having patterns, wherein the material of the patch includes polyurethane.

### BRIEF DESCRIPTION OF THE DRAWINGS

FIG. 1 shows a flowchart of the method for manufacturing a case having figures according to the present invention;

FIG. 2A to FIG. 2C show schematic diagrams of the method for manufacturing a case having figures according to the present invention;

FIG. 3 shows a usage diagram of the method for manufacturing a case having figures according to the present invention;

FIG. 4 shows a structural schematic diagram of the method for manufacturing a case having figures according to the present invention; and

FIG. 5 shows a partially enlarged diagram of the method for manufacturing a case having figures according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

Since the cases according to the prior art own protective function only, the present invention provides a method for manufacturing a case having figures for solving the problem.

In the following, the property, the accompanying structure, and the method in the method for manufacturing a case having figure according to the present invention will be described.

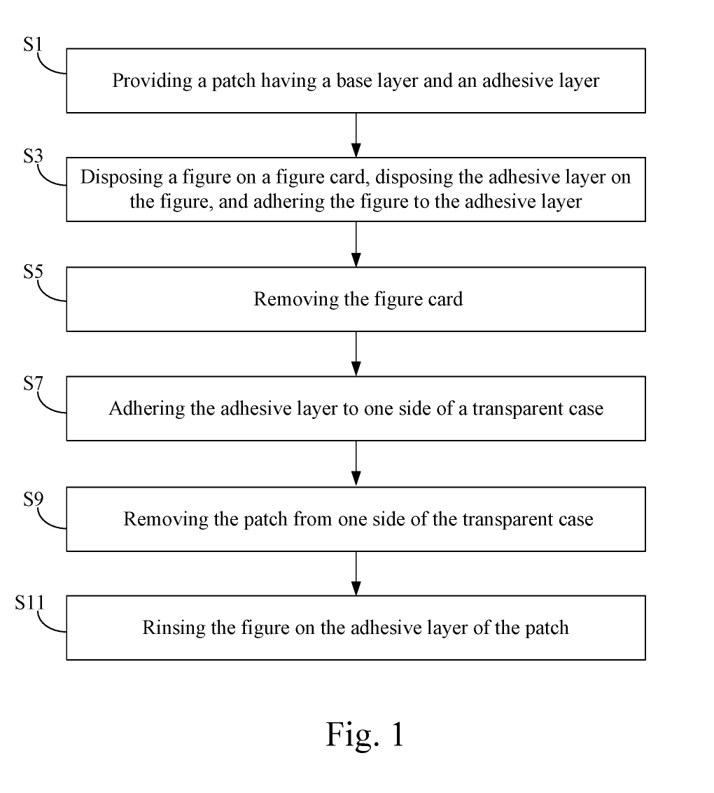

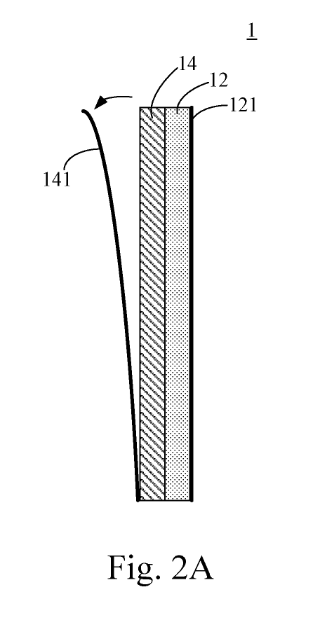

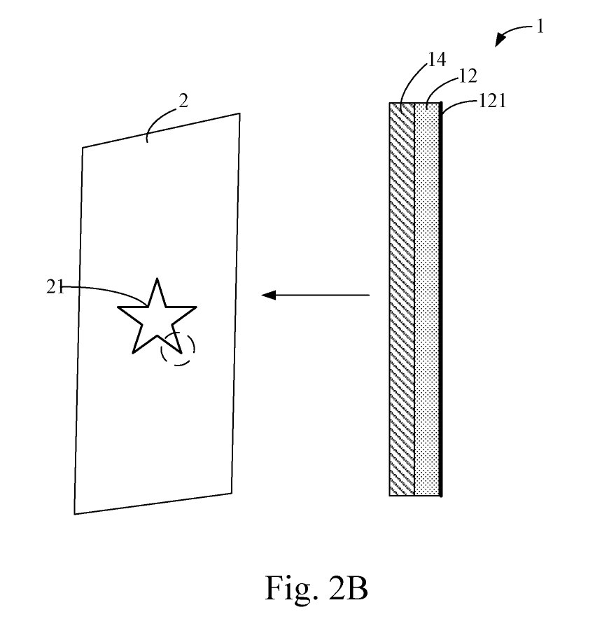

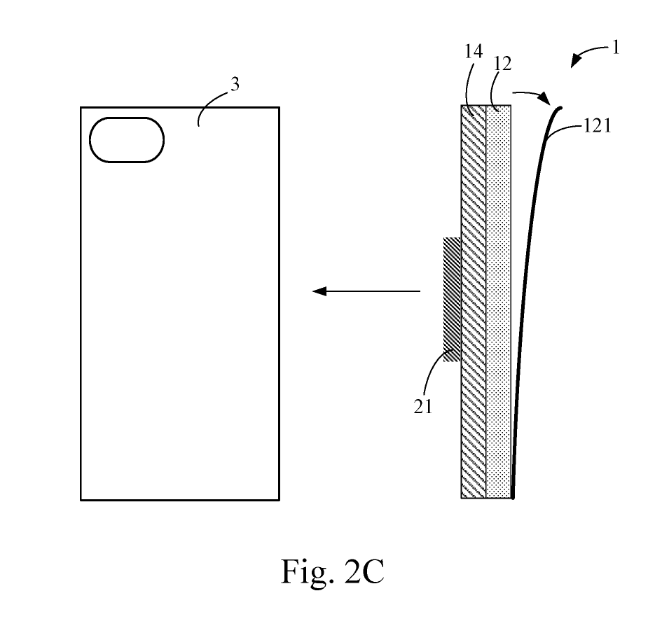

Please refer to FIG. 1 and FIGS. 2A to 2C, which show a flowchart and schematic diagrams of the method for manufacturing a case having figures according to the present invention. As shown in the figures, the method for manufacturing a case having figures according to the present invention comprises steps of:
S1: Providing a patch having a base layer and an adhesive layer;
S3: Disposing a figure on a figure card, disposing the adhesive layer on the figure, and adhering the figure to the adhesive layer;
S5: Removing the figure card; and
S7: Adhering the adhesive layer to one side of a transparent case.

As shown in the step S1, a patch 1 includes a base layer 12 and an adhesive layer 14. The base layer 1 is disposed on upper part of the patch 1; the adhesive layer 14 is disposed on the lower part of the patch 1. The base layer 12 further includes a detachable film 121 on an outer surface, and the adhesive layer 14 further includes a detachable film 141 on an outer surface. When the fabrication of the structure according to the present invention starts, the detachable film 141 on the outer surface of the adhesive layer 14 is detached, as shown in FIG. 2A.

In the step S3, one or more FIG. 21 is disposed on one or more figure card 2. The adhesive layer 14 is adhered to the one or more FIG. 21 for attaching the one or more FIG. 21. The material of the one or more figure card 2 is an oil-proof material; the material of the one or more FIG. 21 is an oily material. In addition, the adherence between the one or more figure card 2 and the one or more FIG. 21 is smaller than the adherence between the adhesive layer 14 and the one or more FIG. 21, as shown in FIG. 2B.

As shown in the step S5, the one or more figure card 2 is removed. The material of the oil-proof material of the one or more figure card 2 includes silicone resin. The oily material of the one or more FIG. 21 includes one or more color pencil, one or more crayon, or one or more oily pen. Besides, the one or more figure card 2 according to a preferred embodiment of the present invention is a baking paper.

As shown in the step S7, after the adhesive layer 14 is adhered to the one or more FIG. 21, adhere the adhesive layer 14 of the patch 1 to one side of a transparent case 3. After adhering the adhesive layer 14, detach the detachable film 121 on the outer surface of the base layer 12, as shown in FIG. 2C.

After the step S7 as described above, the method further comprises steps of:
S9: Removing the patch from one side of the transparent case; and
S11: Rinsing the figure on the adhesive layer of the patch.

As shown in the step S11, the material of the adhesive layer 14 is an oil-proof material. By rinsing, the one or more FIG. 21 of the adhesive layer 14 is removed. Then the adhesive layer 14 can be adhered to the transparent case 3 repeatedly.

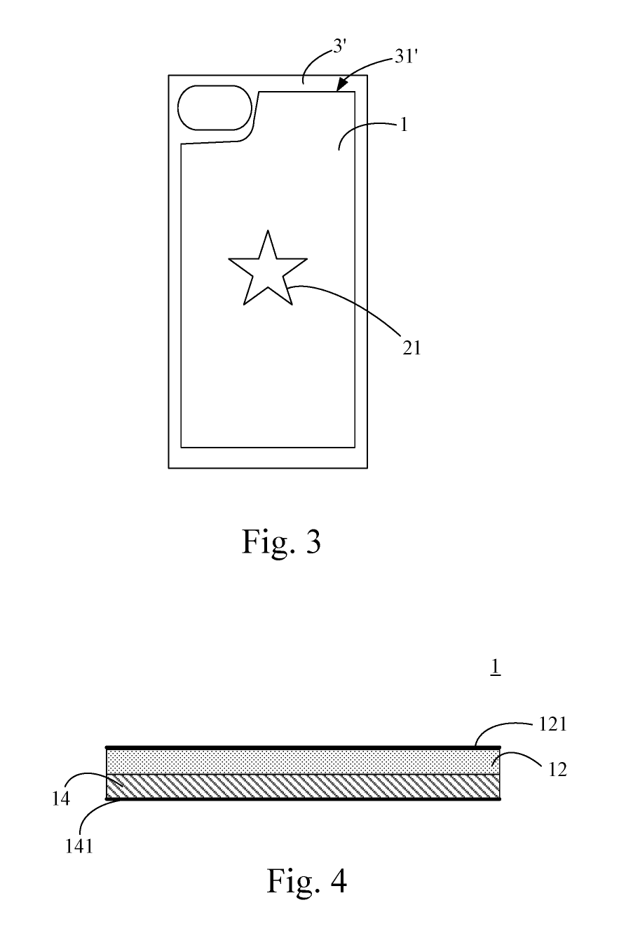

Please refer to FIG. 3, which shows a usage diagram of the method for manufacturing a case having figures according to the present invention. As shown in the figure, the transparent case 3 according to a preferred embodiment of the present invention is a smartphone case 3′. The step S7 further includes a step of adhering the adhesive layer 14 of the patch 1 to a recess 31′ of the smartphone case 3′. The recess 31′ of the smartphone case 3′ includes the one or more FIG. 21. The one or more FIG. 21 is disposed between the recess 31′ and the adhesive layer 14, so that the one or more FIG. 21 is not susceptible to external force or chemical substances such as palm sweat, which might lead to damages.

Next, please refer to FIG. 4, which shows a structural schematic diagram of the method for manufacturing a case having figures according to the present invention. As shown in the figure, the patch 1 includes the base layer 12 and the adhesive layer 14. The base layer 12 is disposed on the upper part of the patch 1 and the adhesive layer 14 is disposed on the lower part of the patch 1. In addition, the base layer 12 include the detachable film 121 on the outer surface and the adhesive layer 14 includes the detachable film 141 on the outer surface. While not using the patch 1, the detachable films 121, 141 act as protective films for the base layer 12 and the adhesive layer 14 for isolating contaminants such as stains or dust.

Moreover, according to a preferred embodiment of the present invention, the material of the patch 1 include polyurethane. By using the chemical property of polyurethane, the adhesive layer 14 of the patch 1 can be adhered repeatedly to one side of the transparent case 3.

Polyurethane (PU) is an elastic material with properties between rubber and plastics. It owns the elasticity of rubber while keeping the high strength of plastics. In addition, the molecular chains of polyurethane contain urethane (—NHCOO—) and isocyanate (—NCO—). Compared to other types of glue, the glue made of polyurethane owns the following features.

Owing to the high-polarity and highly-active radical groups of —NCO— and —NHCOO—, the glue made of polyurethane exhibits excellent chemical adherence with base materials having active hydrogen bonds, such as porous materials including foam, plastics, wood, leather, fabrics, paper, ceramics, or materials having shiny surfaces including metal, glass, rubber, or plastics.

Polyurethane glue can adhere to base materials with distinct thermal expansion coefficients. It also owns superior buffering and shock absorptive functions. Thereby, polyurethane can also buffer the impact applied on smartphones.

Polyurethane glue is hydrolysis resistant, making it superior to other types of glue in rinsing. Hence, by rinsing the one or more FIG. 21 on the adhesive layer 14, the one or more FIG. 21 can be altered at will.

Polyurethane glue is highly lucid and can be adhered for multiple times. Besides, while repeated adhering, no residual glue occurs, which is beneficial for maintaining the transparency of the case 3.

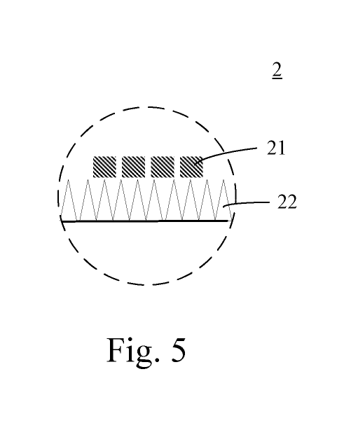

Furthermore, please refer to FIG. 5, which shows a partially enlarged diagram of the method for manufacturing a case having figures according to the present invention. As shown in the figure, the one or more figure card 2 includes a nanostructure 22 on a surface. By using the nanostructure 22, the contact area between the surface of the one or more figure card 2 and the one or more FIG. 21 becomes small, and thus reducing the adherence between the surface and the one or more FIG. 21. When the adhesive layer 14 is adhered to one or more figure card 2, because the contact area between the adhesive layer 14 and the one or more FIG. 21 is large, the adherence between the adhesive layer 14 and the one or more FIG. 21 is stronger, making the one or more FIG. 21 adhered easily to the adhesive layer 14.

In what follows, a preferred practical application of the method for manufacturing a case having patterns according to the present invention will be described.

The FIG. 21 is plotted on the figure card 2. The figure card 2 can have a surface with the nanostructure 22 or include an oily material such as silicone resin. The figure card 2 according to a preferred embodiment of the present invention is a baking paper.

The transparent case 3 according to a preferred embodiment of the present invention is the smartphone case 3′.

After plotting the FIG. 21 on the baking paper, detach the detachable film 141 on the adhesive layer 14 of the patch 1 and adhere the adhesive layer 14 to the FIG. 21 on the baking paper for adhering the FIG. 21. After the FIG. 21 is adhered to the adhesive layer 14, attach the adhesive layer 14 to the recess 31′ of the smartphone case 3′ directly. When the adhering is completed, detach the detachable film 121 on the base layer 12 of the patch 1. Then the case structure having patterns is given.

While replacing the FIG. 21, remove the patch 1 from the smartphone case 3′ and rinse the patch 1 for removing the FIG. 21 on the adhesive layer 14. After adhering a new FIG. 21, reattach the patch 1 to backplate of the smartphone case 3′. Thereby, the FIG. 21 on the smartphone case 3′ can be replaced at will.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A method for manufacturing a case having patterns, comprising steps of:
providing a patch having a base layer and an adhesive layer;
disposing one or more figure on one or more figure card, disposing said adhesive layer on said one or more figure, and adhering said one or more figure to said adhesive layer;
removing said one or more figure card; and
adhering said adhesive layer to one side of a transparent case.

2. The method for manufacturing a case having patterns of claim 1, wherein the material of said one or more figure card is an oil-proof material and the material of said one or more figure is an oily material.

3. The method for manufacturing a case having patterns of claim 1, wherein the material of said adhesive layer is oil-proof glue.

4. The method for manufacturing a case having patterns of claim 2, wherein the adherence between said figure card and said figure is smaller than the adherence between said adhesive layer and said figure.

5. The method for manufacturing a case having patterns of claim 1, and after said step of adhering said adhesive layer to one side of a transparent case, further comprising steps of:
removing said patch from one side of said transparent case; and
rinsing said one or more figure on said adhesive layer.

6. The method for manufacturing a case having patterns of claim 1, and after said step of adhering said adhesive layer to one side of a transparent case, further comprising a step of adhering said adhesive layer of said patch to a recess of a smartphone case.

7. The method for manufacturing a case having patterns of claim 1, wherein said one or more figure card includes a nanostructure on a surface.

8. The method for manufacturing a case having patterns of claim 2, wherein said oil-proof material includes silicone resin.

9. The method for manufacturing a case having patterns of claim 2, wherein said oily material includes one or more color pencil, one or more crayon, or one or more oily pen.

10. The method for manufacturing a case having patterns of claim 2, wherein the material of said patch includes polyurethane.
